(19) United States
(12) Patent Application Publication
(10) Pub. No.: US 2012/0295091 A1
(43) Pub. Date: Nov. 22, 2012

(54) PROCESSES FOR FABRICATING FILMS OF GRAPHENE, CARBON NANOTUBES, AND OTHER CARBON NANOSTRUCTURES ON VARIOUS TYPES OF SUBSTRATES

(75) Inventors: Matteo Pasquali, Houston, TX (US); Robert H. Hauge, Houston, TX (US); Budhadipta Dan, Houston, TX (US); Natnael Behabtu, Wilmington, DE (US); Cary Pint, Houston, TX (US)

(73) Assignee: William Marsh Rice University, Houston, TX (US)

(21) Appl. No.: 13/508,780

(22) PCT Filed: Nov. 9, 2010
(86) PCT No.: PCT/US2010/056053

§ 371 Date: Aug. 3, 2012

Related U.S. Application Data
(60) Provisional application No. 61/259,525, filed on Nov. 9, 2009.

(51) Int. Cl. C01B 31/00; B32B 9/00; B32B 37/24; C01B 31/02; D01F 9/12; B82Y 40/00; B82Y 30/00

(52) U.S. Cl. 428/220; 428/408; 423/445 R; 423/447.2; 423/448; 423/445 B; 156/62.2; 977/755; 977/788; 977/750; 977/752; 977/734; 977/890

(57) ABSTRACT

Methods for producing carbon films are disclosed herein. The methods include treating a carbon nanostructure with one or more dispersing agents, filtering the solution through a filter membrane to form the carbon film, releasing the carbon film from the filter membrane, and transferring the film onto a desired substrate without the use of sonication. Carbon films formed by said methods are also disclosed herein.

### CROSS REFERENCE TO RELATED APPLICATIONS

This application claims priority to U.S. Provisional Patent Application No. 61/259,525, the entirety of which is incorporated herein by reference.

### STATEMENT REGARDING FEDERALLY SPONSORED RESEARCH

This invention was made with government support under grant no. GS9550-09-0590 awarded by the U.S. Air Force Office of Scientific Research (AFOSR); grant no. USACE291HZ-08-C-0054 awarded by the U.S. Army and the Department of Defense through the U.S. Army Engineer Research and Development Center (ERDC); and grant no. 9-S568-064-01-C1 awarded by the U.S. Air Force Research Laboratory (AFRL) and Universal Technology Corporation. The government has certain rights in the invention.

### BACKGROUND OF THE IN VENTION

Various carbon nanostructures, such as carbon nanotubes, graphene and fullerenes, have optimal properties for numerous applications. In particlular, their high electrical and thermal conductivity, high aspect ratio, high mechanical strength and chemical inertness make these materials ideal candidates for a variety of applications.

Certain applications require carbon nanostructures to be cast in the form of thin films, where their performance typically depends on the thicknesses at which the films can be cast in a uniform and controlled manner. The properties of the films also scale strongly with the length and diameter of the nanotubes and the size of the graphene flakes making up the thin film. It is therefore necessary to develop more efficient and cost-effective approaches to fabricating films of carbon nanostructures (i.e., carbon films) for a variety of applications.

### BUFF SUMMARY OF THE INVENTION

In some embodiments, the present disclosure pertains to methods for preparing carbon films by treating a carbon nanostructure with one or more dispersing agents (e.g., acids and organic solvents) and filtering the carbon nanostructure through a filter membrane. In further embodiments, the methods further comprise releasing the carbon nanostructure from the filter membrane and transferring the film onto a desired substrate. Desirably, the methods of the present disclosure occur without the use of sonication.

In various embodiments, such methods provide new processes for the fabrication of free floating carbon carbon films from various carbon nanostructures (e.g., carbon nanotubes, graphene, graphite, fullerenes, and combinations thereof). Other embodiments of the present invention also comprise methods of fabricating ultra-thin transmission electron microscopy (TEM) grids that permit imaging at very high resolution. Further embodiments of the present invention comprise a method of visualizing small nanoparticles using such ultra-thin TEM grids. The carbon films produced by the methods described herein also comprise an embodiment of the invention.

The methods and compositions of the present invention allow for more efficient and effective approaches to fabricating carbon films, which are desirous for a variety of applications, including TEM.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE FIGURES

In order to fully comprehend the above recited methods and their advantages, a more particular description of the invention briefly described above will be rendered by reference to specific embodiments thereof, which are illustrated in the appended Figures. Understanding that these Figures depict only typical embodiments of the invention and are therefore not to be considered limiting of its scope, the invention will be described with additional specificity and detail through the use of the accompanying Figures in which:

FIG. 1 illustrates the various steps involved in the fabrication of thin carbon films from acid.

FIG. 1A shows a simple filtration setup used with house vacuum and alumina filters (Anodisc 47 0.02 um pore size, Whatman).

FIG. 1B shows filtration of the acid/carbon nanotube (CNT) mixture.

FIG. 1C shows filtration of the chloroform to remove residual solvent from filter once filtration of the acid/CNT mixture is complete (few tens of seconds for 5 ml of solution). Chloroform or dichloromethane are usually used during this step because they mix with chlorosulfonic acid with no reaction and negligible heat of mixing.

FIG. 1D shows the immersion of the produced thin film in a large beaker filled with water.

FIG. 1E shows that upon slowly immersing the alumina filter in water, the CNT thin film detaches itself from the membrane which falls to the bottom of the beaker.

FIG. 1F shows the formation of a free-standing thin film (circled in dotted lines to distinguish it from the membrane), which can be lifted into a TEM grid and/or glass substrate for further characterizations.

FIG. 1G and FIG. 1H provide further illustrations of the formed free standing film.

FIG. 2 illustrates a single walled nanotube (SWNT) TEM grid fabricated using purified HiPco SWNT.

FIG. 2A and FIG. 2B show low and high magnification images of a thin film produced by filtering 5 ml of 5 ppm wt % SWNT/chlorosulfonic acid solution on an anodisc filter (20 nm pore size, 47 mm diameter), which yields an area coverage of 1.5 mg/mm².

FIG. 2C and FIG. 2D depict low and high magnifications of a thin film obtained by filtering half the concentration of the initial solution. To have comparable filtration time, we have kept the amount of filter fluid constant. The produced thin films are large enough to be suspended on a transparent substrate and be characterized for transparency and sheet resistance. The scale bars are 500 and 100 nm for FIGS. 2A and 2B, respectively. FIGS. 2C and 2D were taken at the same magnification as FIGS. 2A and 2B, respectively. The images were acquired using JEOL 2010, operated at 100 KV.

FIG. 3 illustrates the potential advantage in using CNT grids for cryo-TEM. Cryo-TEM sample preparation requires very thin liquid films to be formed and vitrified. As for standard TEM, the thinner the film, the better the attainable contrast. Thin liquid films will usually have a biconcave shape. The thinnest point h depends on a number for variable such as contact liquid solid contact angle, liquid/air surface tension as well as the grid pore size d and 1. CNT grids have d comparable to their diameter (˜10 nm or below) and can give liquid films that are thinner compare to standard TEM grids where d˜100-200 nm.

FIG. 4 illustrates the images obtained using CNT as a support grid.

FIG. 4A and FIG. 4B are a low and high magnifications of the FeCu nanoparticle, respectively. At low magnification, the high surface area that nanotube grids offer for nanoparticles to adhere can be seen.

FIG. 4C illustrates the visualization of the same batch of nanoparticles in FIGS. 4A and 4B using SWNT grids.

FIG. 4D illustrates the visualization of the same batch of nanoparticles in FIGS. 4A and 4B using carbon lacey carbon grid.

FIG. 4E and FIG. 4F are magnified views of single nanoparticles from each grid. The signal to noise ratio is higher for the nanoparticle visualized using CNT grids.

FIG. 5 illustrates images of a grapheme flake.

FIG. 5A shows a low magnification image of a graphene flake suspended on a multi-walled nanotube (MWNT) grid.

FIG. 5B shows a high magnification of the fold (highlighted by the red box) visible in the low magnification image.

FIG. 5C and FIG. 5D are images of the same flake in FIGS. 5A and 5B visualized using secondary electron and scanning transmission electron microscopy. Note how the flake is clearly visible using secondary electrons.

FIG. 5E illustrates a low magnification view of a larger area of graphene flakes. The image was used to assess the larger size distribution of the graphene flakes. The scale bars are 100 nm, 10 nm, and 400 nm for FIGS. 5A, 5B, and 5C, respectively. The scale bar is 4 μm for FIG. 5E.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

To date, various methods have been developed for fabricating thin carbon films with thicknesses ranging from several hundred carbon nanotube (CNT) layers (>50-100 nm) to thicknesses of several microns. However, there is currently no known method for fabricating free floating CNT films that are only a few CNT layers thick (e.g., 10 nm or less) or possess a monolayer thickness over smaller areas. Several difficulties have prevented the development of such thin films, including the inability of the current dispersion techniques (involving surfactants and sonication, which reduces the size of carbon nanostructures) to generate films with individually present and long allotropes of carbon (e.g., long nanotubes or large graphene flakes) of sufficient mechanical strength and integrity to permit transfer to various substrates. Furthermore, films formed from surfactant solutions may contain the surfactant. To the best of Applicants' knowledge, this disclosure describes the first example of a method of fabricating free floating carbon films of carbon nanostructures for a variety of applications.

Various embodiments of the present disclosure pertain to methods for preparing carbon films by: (1) treating a carbon nanostructure with one or more dispersing agents (e.g., acids and organic solvents); (2) filtering the carbon nanostructure through a filter membrane to form the carbon film; (3) releasing the carbon nanostructure from the filter membrane; and (4) transferring the film onto a desired substrate. Desirably, the aforementioned steps occur without the use of sonication. Various embodiments of the present disclosure may pertain or one or more of the above-mentioned steps. Further embodiments of the present disclosure pertain to carbon films derived from the aforementioned methods. Reference will now be made to various aspects of the present invention.

Carbon Nanostructure

In various embodiments, the carbon nanostructure used to make carbon films comprises one or more of the following materials: carbon nanotubes, including single-walled nanotubes (SWNTs), double-walled nanotubes (DWNTs) and/or multi-walled nanotubes (MWNTs); graphene; graphite; fullerenes, and/or combinations thereof. In various embodiments, the carbon nanostructure can be pristine, functionalized, non-functionalized, and/or oxidized. Likewise, carbon nanostructures of the present disclosure can be associated with various compounds, such as polymers, surfactants, and/or dispersing agents. The carbon nanostructures of the present disclosure are generally transferable to a variety of substrates.

In a specific embodiment, the carbon nanostructure is SWNTs. Other suitable carbon nanostructures not disclosed here can also be envisioned by persons of ordinary skill in the art.

Dispersing Agents & Treatment

Dispersing agents in the present disclosure generally refer to compounds that can substantially separate a carbon nanostructure from other compounds, such as polymers, surfactants and other dispersing agents. In various embodiments, the dispersing agents used are acids (e.g., chlorosulfonic acid), a combination of two or more acids, or a combination of one or more acids and one or more organic solvents (e.g., chloroform and/or dichloromethane).

In some embodiments, suitable acids to be used as dispersing agents can include one or more superacids, as known by persons of ordinary skill in the art. In some embodiments, the superacid may be one or more of a Bronsted superacid, a Lewis superacid, and/or a conjugate Bronsted-Lewis superacid.

In some embodiments, Bronsted superacids may include, without limitation, perchloric acid, chlorosulfonic acid, fluorosulfonic acid, trifluoromethane sulfonic acid, methane sulfonic acid, and higher perfluoroalkane sulfonic acids (C₂F₅SO₃H, C₄F₉SO₃H, C₅F₁₁SO₃H, C₆F₁₃SO₃H, and C₈F₁₇SO₃H, for example).

In some embodiments, Lewis superacids may include, without limitation, antimony pentafluoride and arsenic pentafluoride. In some embodiments, Bronsted-Lewis superacids may include, without limitation, sulfuric acids containing various concentrations of SO₃, also known as oleums or fuming sulfuric acid. Other Bronsted-Lewis superacids may include, but are not limited to, polyphosphoric acid-oleum mixtures, tetra(hydrogen sulfate)boric acid-sulfuric acid, fluorosulfuric acid-antimony pentafluoride (“magic acid”), fluorosulfuric acid-SO₃, fluorosulfuric acid-arsenic pentafluoride, fluorosulfonic acid-hydrogen fluoride-antimony pentafluoride, fluorosulfonic acid-antimony pentafluoride-sulfur trioxide, fluoroantimonic acid, and tetrafluoroboric acid.

In more specific embodiments, suitable acids to be used as dispersing agents can include, without limitation, chlorosulfonic acid, sulfuric acid, trifluoromethanesulfonic acid, fluorosulfonic acid, triflic acid, and combinations thereof. In further embodiments, the superacid to be used a a dispersing agent is chlorosulfonic acid.

Various other suitable acids to be used as dispersing agents can be the acids disclosed in Patent Application Pub. No. WO 2009/058855. The entirety of this application is incorporated herein by reference.

In some embodiments, the dispersing agents can include one or more acids in combination with one or more organic solvents. For instance, in some embodiments, suitable organic solvents to be used as dispersing agents can include, without limitation, tetrachloroethylene, toluene, chloroform, dichloromethane, ether and combinations thereof. Other suitable organic solvents can also be envisioned by persons of ordinary skill in the art.

In more specific embodiments, the dispersing agent is a combination of chloroform and chlorosulfonic acid. Other suitable dispersing agents and variations thereof can also be envisioned by persons of ordinary skill in the art. For instance, in some embodiments, the dispersing agent is chlorosulfonic acid mixed with dichloromethane as the organic solvent.

Applicants also note that various components of the dispersing agents of the present disclosure can be applied to carbon nanostructures simultaneously or sequentially. For instance, in some embodiments, the carbon nanostructure may be treated with one or more acids (e.g., chlorosulfonic acid) and then treated with one or more organic solvents (e.g., chloroform). In other embodiments, the carbon nanostructure may be simultaneously treated with chloroform and chlorosulfonic acid.

Further embodiments of the present disclosure comprise adding other desirable additives to dispersing agents in the acid solution and depositing them together with the carbon nanostructure, so as to retain them in the solid film.

Filtration

Various methods of filtering carbon nanostructures can be envisioned by persons of ordinary skill in the art. For instance, in some embodiments, the filtration steps may occur by the use of filters that comprise a pore size of about 20 nm. In some embodiments, the filter membrane may have a pore size of about 10 nm to about 100 nm. In more specific embodiments, the filter to be used is an Anodisc 47 Whatman filter.

Release of the Carbon Nanostructure from the Filter Membrane

A person of ordinary skill in the art can also envision various methods of releasing a carbon nanostructure from a filter. For instance, in some embodiments, the carbon nanostructure may be released from the filter by slowly submerging the filter membrane onto a beaker of water.

Film Transfer

Various methods can also be envisioned for transferring carbon films of the present disclosure onto a desired substrate. Exemplary methods include, without limitation, film coating, air-spraying, spin coating, coating onto a permeable screen, and coating onto a permeable substrate wrapped on a permeable screen.

Carbon Films

In some embodiments, the carbon films produced by the methods of the present invention are monolayers. In some embodiments, the carbon films can be a few layers thick. In some embodiments, the carbon films have a thickness of less than about 20 nm. In some embodiments, the carbon films have a thickness of less than about 10 nm. In more specific embodiments, carbon films of the present invention float freely in water (i.e., free floating ultra-thin films). In further embodiments, the carbon films of the present invention are substantially free of polymers, surfactants and dispersing agents (e.g., a purity of between about 85% to about 100% by weight).

The carbon films of the present disclosure can also have carbon nanostructures of various lengths. For instance, in some embodiments the carbon films can have carbon nanostructures with lengths of more than about 500 nm. In some embodiments, the carbon films have carbon nanostructures with lengths of about 500 nm to about 2 μm. In some embodiments, the carbon films have carbon nanostructures with lengths of more than about 2 μm. Applicants note that an advantage of not using sonication in various methods of the present disclosure includes the attainment of carbon films with carbon nanostructures that have longer lengths (e.g., above 500 nm).

Various attributes of the carbon films of the present disclosure can include mechanical strength, conductivity (both thermal and electrical), chemical inertness, and transparency. For instance, in some embodiments, the carbon films of the present disclosure may have transparencies that range from about 75% to about 100%. Likewise, in some embodiments, the carbon films of the present disclosure may have a sheet resistance of about 295 Ω/sq to about 4000 Ω/sq.

Accordingly, the carbon films of the present invention can be used in various settings. For instance, in some embodiments, the carbon films can be used as nanoporous membranes, filtration membranes, microscopy grids, chemical and biological sensors, electronic material, and photonic material.

The carbon films of the present invention can also be used for a variety of applications. Such applications can include, without limitation, transparent conductive films for touch screens, display technologies, solid state lighting; and electrodes for fuel cells, solar cells, batteries, electromagnetic shields, smart windows, and filters for water filtration and sterilization. Other commercial applications for the carbon films of the present invention can also be envisioned by persons of ordinary skill in the art.

As set forth previously, carbon films of the present disclosure can be formed from various carbon nanostructures that may be functionalized, non-functionalized, pristine, and/or oxidized. In more specific embodiments, carbon films may be derived from functionalized CNT films according to the methods described herein.

Fabrication of Carbon Films (Specific Embodiment)

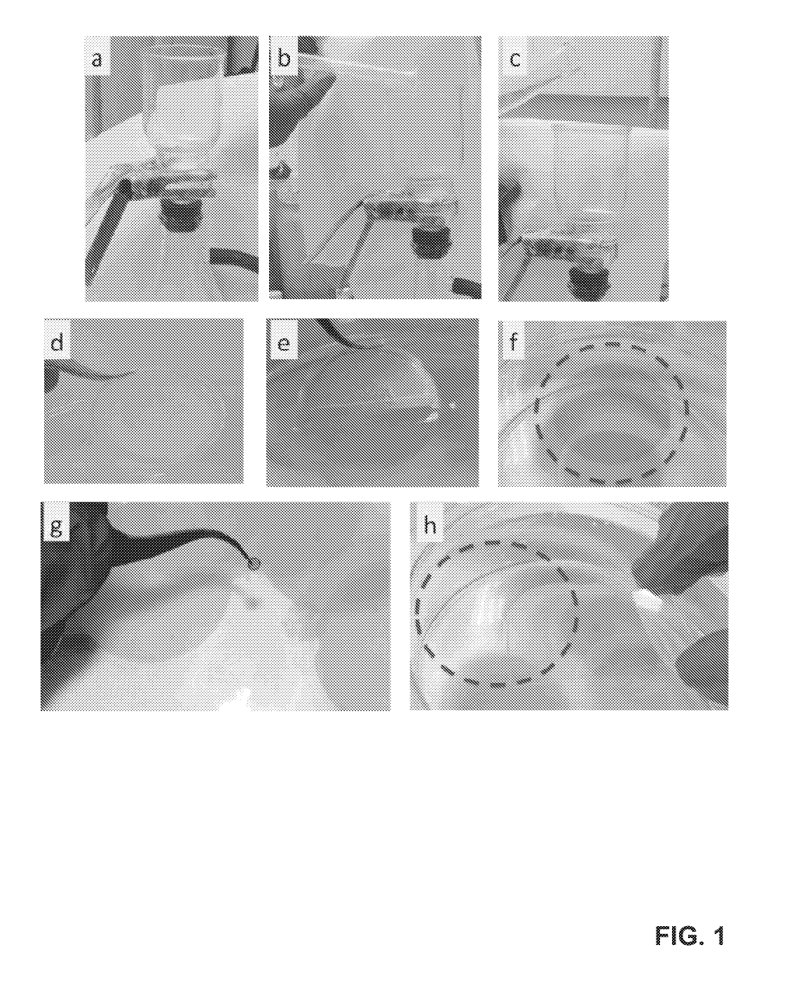

A specific embodiment of the present invention for preparing a free floating carbon film is more clearly outlined in FIG. 1 as follows. A carbon nanostructure (SWNT) is dispersed in chlorosulfonic acid to form an acid/CNT mixture. Using a filtration system as in FIG. 1A comprising a house vacuum with alumina filters (Anodisc 47 0.02 um pore size), the acid/CNT mixture is then filtered, as depicted in FIG. 1B. Once the filtration is complete (which may take about few tens of seconds for 5 ml of solution), chloroform is added to remove residual solvent from the filter, as in FIG. 1C. Chloroform or dichloromethane are usually used during this step because they mix with the cholorosulfonic acid without any reaction and negligible heat of mixing. The produced thin film attached to the filter as in FIG. 1D is then immersed in a large beaker of water. By slowly immersing the alumina filter unto which the film is attached (in water, as in FIG. 1E), the CNT thin film detaches itself from the membrane while the membrane falls to the bottom of the beaker. A free standing thin film as depicted in FIG. 1F is thus formed and can be lifted into a TEM grid and/or glass substrate for further characterizations, as in FIGS. 1G and 1H. The carbon films fabricated by this method have a thickness ranging from a monolayer to a few layers of about 0-20 nm, although thicker films can be made by running the process for longer periods at higher solid concentrations.

Advantages and Applications

The films manufactured by the methods of the present invention can be substantially free of any additional polymers, surfactants or other dispersing agents and include primarily the carbon nanostructure. However, other components may be added to the carbon films, as desired.

Furthermore, the methods of the present invention can facilitate fabrication of carbon films using carbon nanotubes of arbitrarily long lengths (several microns and above), without inducing any cuffing, functionalization or other kind of damage to the nanotubes. Since the process allows fabrication of films with arbitrarily long carbon nanotubes without causing any functionalization, cutting or damage to the nanotubes, the properties of the films produced by this method are significantly better than the current state-of-the-art carbon nanotube films. The methods of the present invention can also produce the final film in a free floating form, which allows easy transfer to any substrate of interest.

The methods of the present disclosure can be used to make several micrometer long films of carbon nanotubes, including nanotubes that are hundreds of micrometers long. By utilizing super acids, such as chlorsulfonic acid, various methods of the present invention can also individualize and dissolves CNTs, graphene and fullerenes without employing sonication or functionalization. As such, the nanotubes are not shortened nor damaged.

The methods of the present invention also allow the removal of the residual acid and other co-solvents by annealing the films at moderate temperatures. Furthermore, given that polymers or surfactants may be absent from the methods of the present invention (which negatively affect the properties of CNT films made by other methods), the manufactured carbon films can be substantially free of residual material. The properties of the carbon films made using the present methods are significantly better than current state-of the art carbon films and can be readily extended to large areas by using large filters that can be rolled onto cylindrical screens.

The present invention also provides methods that can make monolayers of carbon films, such as monolayers of CNTs, graphene or combinations thereof. In addition, the present invention provides methods that can make carbon films that are just a few layers in thickness. Without being bound by theory, Applicants envision that the ability of various acids (e.g., chlorosulfonic acid or other superacids) to individualize and disperse long CNTs without any sonication, functionalization or use of additives allows the formation of such thin films.

Applicants also envision the use of the acid-carbon nanostructure solution to be used for controlled, efficient and homogenous functionalization of carbon nanostructures (e.g., CNTs) for formation of thin carbon films with specially tailored properties. Because the carbon nanostructures may be dissolved as bare individuals, without substanial coatings of surfactants, polymers or dispersing agents, the methods of the present invention can also allow liquid phase mixing of nanoparticles and/or selected polymers with the carbon nanostructure before or during the film formation process.

Applicants also envision that the manufactured carbon films of the present invention possess enough mechanical strength so that the films can be recovered in a free floating form that allows them to be easily transferred to any substrate of interest. The ability to make such thin films in a uniform and reproducible way, and the flexibility of the substrates, opens up a wide range of new potential applications.

Additional Embodiments

From the above disclosure, a person of ordinary skill in the art will recognize that the methods and compositions of the present disclosure can have numerous additional embodiments. Reference will now be made to more specific embodiments of the present disclosure and experimental results that provide support for such embodiments. However, Applicants note that the disclosure below is for exemplary purposes only and is not intended to limit the scope of the claimed invention in any way.

### EXAMPLE

Additional details about a specific application requiring cabaceous allotropes cast in the form of thin carbon films formed by the above-described methods is discussed in the subsections below.

The advent of nanotechnology has made Electron Microscopy (EM) a routine and powerful characterization technique. It is often utilized to assess the product of a synthesis and check if a desired shape, size and crystallinity is attained. In some cases, such as graphene, it can be a very powerful tool to assess single versus multi layer formation and for size characterization. Sample preparation is an essential step for good imaging. In fact, evolution in protocols for sample preparation can be as critical as evolution of the instrument itself.

When visualizing nanometer-sized particles, a thin film of amorphous carbon is typically used on a metal grid to support the specimen being visualized. State of the art carbon carbon film has a thickness of 3 nm in its thinnest portion. Low film thickness of substrate is important because one of the contrast mechanisms in electron microscopy is mass thickness contrast, whereby atoms with higher atomic number or thicker areas appear darker when visualized using bright field microscopy. This is because thicker regions and higher atomic number diffract electrons to a larger extent. Carbon has been the material of choice because it has a low atomic number. Thus, thin carbon films are largely used as a TEM support material. The support must be electrically conductive to avoid charging effects. Thus, the optimal support has to be conductive, very thin, and contian a low atomic number. Controllable pore size, high surface area, along with chemical, thermal and mechanical stability are also desirable.

Super-aligned carbon nanotube forests and CVD-grown graphene flakes can be used as TEM grid support. Because of their properties and thinness, CNT and graphene TEM grids are one of the most promising current alternatives to conventional TEM grids. However, fabricating these structures is difficult. CNTs must be grown by CVD in a confirguration that can be spun into membrane arrays. Graphene must be grown into extremely large flakes grown on metals that are removable from the substrate.

Solution processed graphene oxide thin films have also been used as TEM grids. However, such materials have limited applicability because of their easy dissolution in solvents and poor thermal stability.

Thus, various aspects of the invention present a simple and highly reproducible technique for fabricating electron microscopy imaging supports from readily available commercial CNTs and graphite. The resulting carbon supports are mechanically stable and have high electrical and thermal conductivity and chemical inertness.

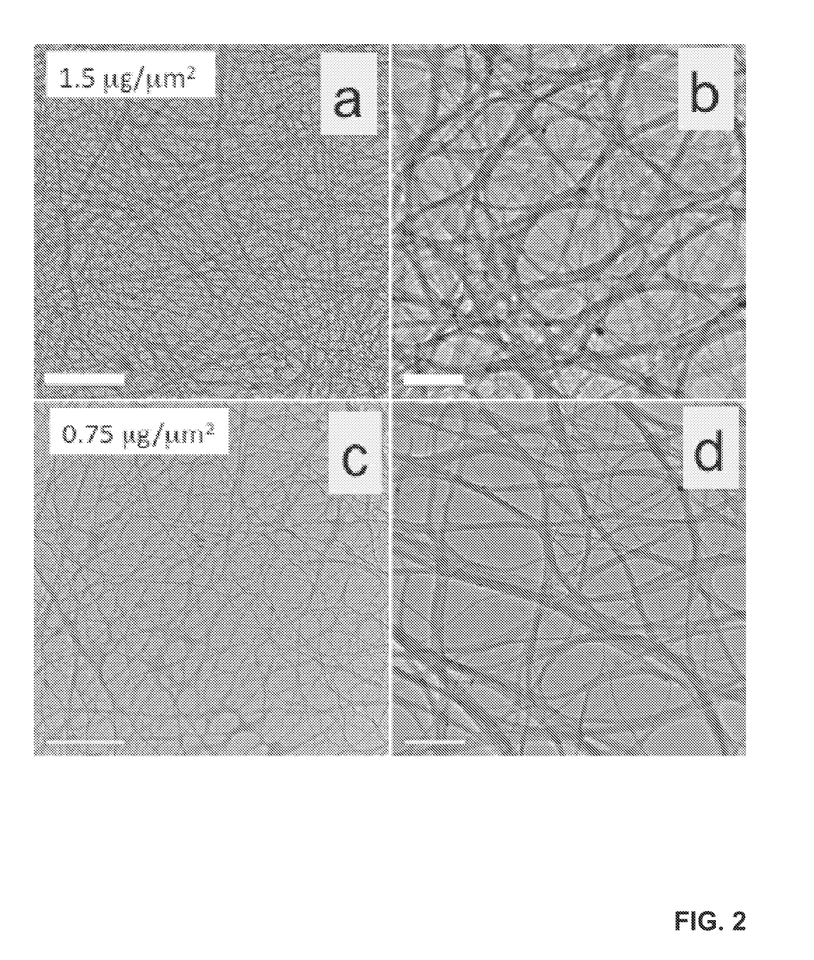

To produce the desired carbon film, raw material SWNT powder or graphite was dissolved into individual nanoparticles (SWNTs or graphene flakes) in chlorosulfonic acid at low concentration (5-50 ppm) using previously established methods. Carbon films were formed through simple vacuum filtration of these solutions through commercial 20 nm pore size alumina membranes, followed by washing with a quenching solvent (chloroform) that neutralized any residual acid trapped in the film. The films produced were detached from the filter by immersing the alumina membrane in water. The manufactured films floated on the water surface and could then be transferred onto a standard TEM grid. See FIG. 1. Film thickness and porosity was controlled by the amount of mass deposited per unit area. See FIG. 2. Robust and transferable thin films were reliably formed using a number of CNT materials including high-pressure CO conversion (HiPCO) SWNT, laser oven SWNT, chemical vapor deposition (CVD) grown SWNT carpets and MWNTs carpet. The key requirement here was to achieve individualized dispersion of nanotubes without compromising their length and aspect ratio.

SWNT carbon films have been fabricated from surfactant and organic solvent/SWNT dispersions by using sonication, which reduces the tube length, compromising the film mechanical stability. Carbon films (transparency above 90%) formed from surfactant and organic solvent dispersions broke at the air water interface during the transfer process. A wide range of carbon nanotubes and graphene dissolve spontaneously in acids without sustaining any damage. Thin films produced using acid solutions are also highly conducting. We have measured sheet resistance of 295 Ω/sq and 4000 Ω/sq at 92% transparency for laser oven SWNTs and MWNTs, respectively.

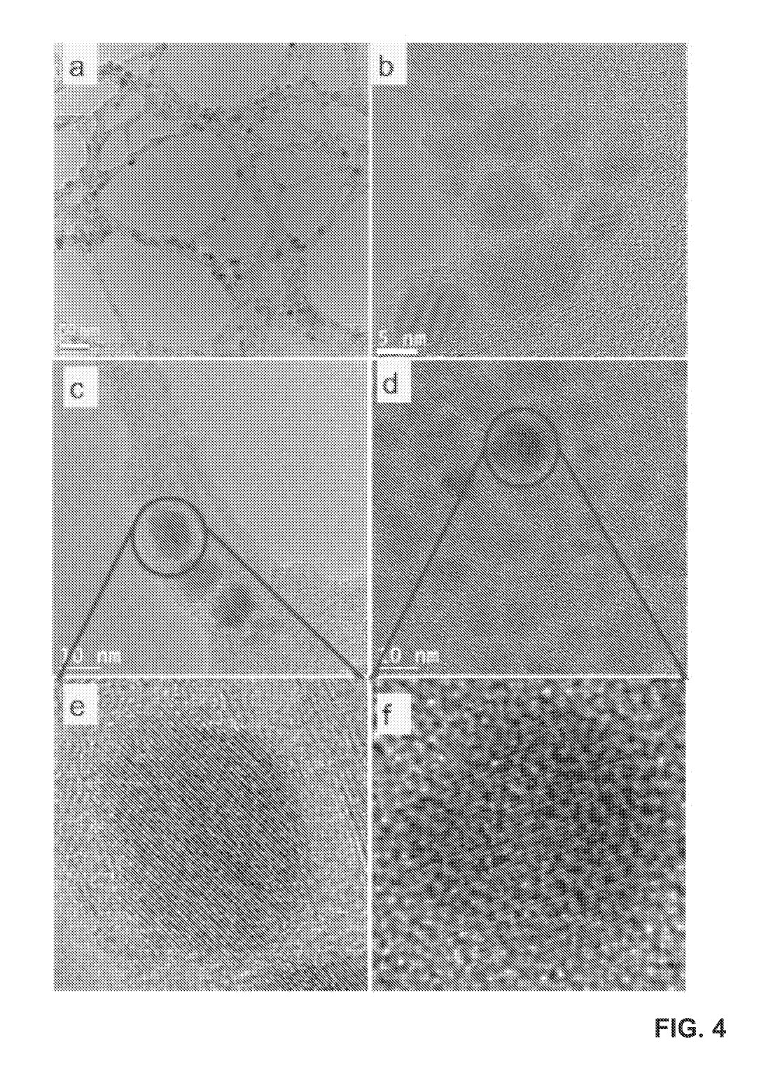

We used FeCu nanoparticles as well as graphene flakes to test the imaging performance of our CNT grids. FeCu particles were synthesized by co-condensation of metal acetyleacetonate precurors. Both samples are particularly challenging to visualize. FeCu nanoparticles must lay on very thin supports of thickness comparable to their size (˜few nm) for atomic resolution imaging. Graphene flakes are even more challenging because carbon has a low atomic number (the same as the support grid when using amorphous carbon support) and sub-nanometer thickness. FIG. 4 shows FeCu nanoparticles at low and high resolution. At low magnification, it is possible to appreciate how CNT films offer large surface area for nanoparticles to adhere to. See FIG. 4A. The high magnification image FIG. 4B shows how atomic resolution is readily achieved. Images acquired under the same TEM operation conditions (same instrument, voltage, exposure time, condenser aperture and electron density) using state of the art carbon lacy carbon has a lower signal to noise ratio when compared to images acquired with carbon nanotube grids.

As a second example, we visualized individual and few layer graphene flakes initially dissolved in super acid. Standard sample preparation (dip coating of the grid in acid and drop drying on the TEM grid) proved to be unsuccessful. The high reactivity and high boiling point of the solvent and moisture instability of the solution makes sample preparation using standard techniques prohibitive. This problem can be overcome by first vacuum filtering the CNT solution to form the support film and then filtering the graphene solution on top. After this point, the procedure becomes the same as CNT grid preparation. This technique can be easily extended to other fluids and it can be particularly useful when dealing with high boiling point, hygroscopic and reactivefluids.

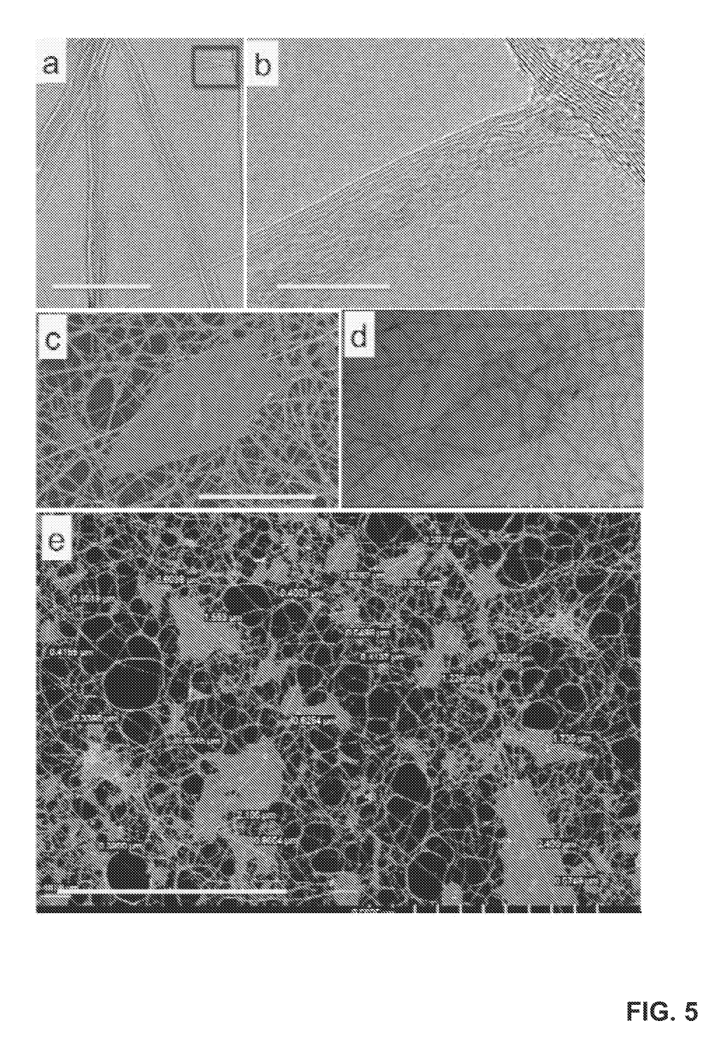

FIG. 5 shows a low and high magnification image of graphene flakes. The attained contrast is remarkable and makes flake identification under TEM an easy task. The same sample preparation can also be used to assess the graphene flake size. See FIG. 5E. In fact, flake identification becomes even easier when the sample is visualized using secondary electrons. Thin supports are also very useful when visualizing nanometer-sized samples in secondary electron mode. In fact, porous structure of CNT support film results in remarkably low interaction volume (the volume that produce the secondary electrons used to image) from the substrate, making graphene flakes highly visible.

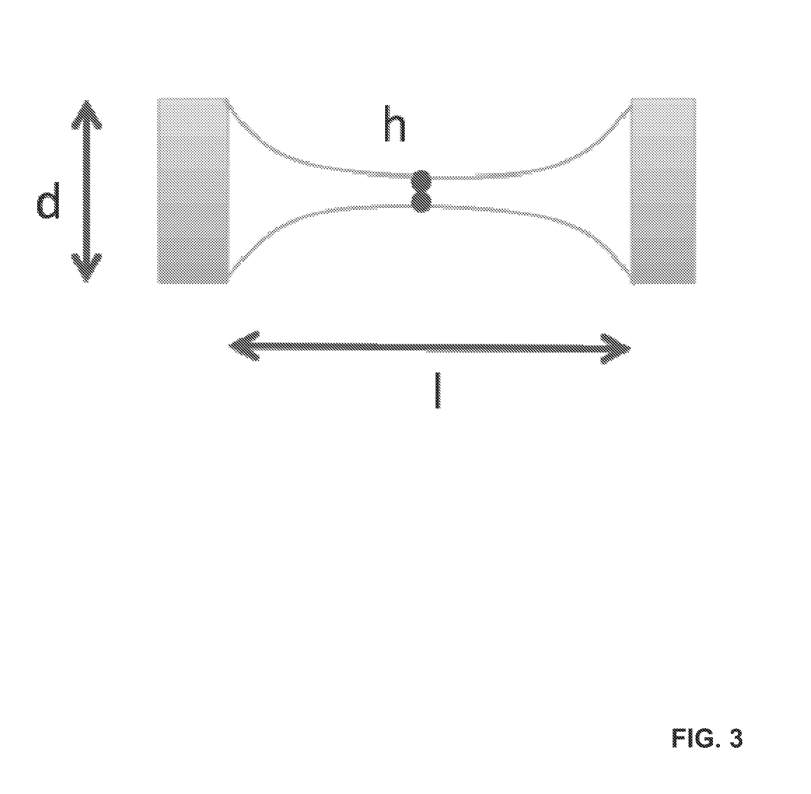

In sum, we have successfully made graphene thin films with transparency of 80% containing about ˜9 layers of graphene and having a thickness of about 3 nm. We also envision that the small diameter of of MWNT and SWNT bundles will allow for thinner films to be formed, as illustrated in the schematic drawing in FIG. 3. Thin liquid specimens are essential to gain contrast in cryo-TEM since vitrified liquid scatter electron reduces the signal to noise ratio.

The results from the above described examples demonstrate a facile route to fabricate TEM grids using solution CNT and graphene solution processing. Additionally, the results also demonstrate the optimal performance of the grid produced to visualize small nanoparticles as well as to prepare TEM grids from reactive fluids, such as acids. The chemical inertness, thermal stability, electrical conductivity and porous microstructures of the grids in this invention can enable novel sample preparation and optimal imaging compared to standard TEM grids.

Without further elaboration, it is believed that one skilled in the art, can, using the description herein, utilize the present invention to the fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teaching of the invention. Accordingly, the scope of protection is not limited by the description set out above, but is only limited by the claims, including all equivalents of the subject matter of the claims. The disclosures of all patents, patent applications and publications cited herein are hereby incorporated by reference, to the extent that they provide procedural or other details consistent with and supplementary to those set for the herein.

What is claimed is:

1. A method for preparing a carbon film, wherein the method comprises:
treating a carbon nanostructure with one or more dispersing agents;
filtering the carbon nanostructure through a filter membrane to form the carbon film;
releasing the carbon film from the filter membrane; and
transferring the carbon film onto a desired substrate, wherein the method occurs without the use of sonication.

2. The method of claim 1, wherein the desired substrate is a TEM grid.

3. The method of claim 1, wherein the one or more dispersing agents comprises a superacid.

4. The method of claim 1, wherein the one or more dispersing agents comprises chlorosulfonic acid.

5. The method of claim 1, wherein the one or more dispersing agents comprises chlorosulfonic acid and an organic solvent, wherein the organic solvent is selected from the group consisting of chloroform and dichloromethane.

6. The method of claim 5, wherein the treating of the carbon nanostructure with one or more dispersing agents comprises the sequential treatment of the carbon nanostructure with chlorosulfonic acid and the organic solvent.

7. The method of claim 1, wherein the carbon nanostructure is selected from the group consisting of SWNTs, DWNTs, MWNTs, graphene, graphite, fullerenes, and combinations thereof.

8. The method of claim 1, wherein the carbon film has a thickness of less than about 20 nm.

9. The method of claim 1, wherein the carbon film has a thickness of less than about 10 nm.

10. The method of claim 1, wherein the carbon film comprises carbon nanostructures with lengths of more than about 500 nm.

11. A carbon film, wherein the carbon film is prepared by a method comprising:
treating a carbon nanostructure with one or more dispersing agents;
filtering the carbon nanostructure through a filter membrane to form the carbon film; and
releasing the carbon film from the filter membrane, wherein the method occurs without the use of sonication.

12. The carbon film of claim 11, wherein the carbon film is a monolayer.

13. The carbon film of claim 11, wherein the carbon film floats freely in water.

14. The carbon film of claim 11, wherein the carbon film comprises multiple layers.

15. The carbon film of claim 11, wherein the carbon film has a thickness of less than about 10 nm.

16. The carbon film of claim 11, wherein the carbon nanostructure is selected from the group consisting of SWNTs, DWNTs, MWNTs, graphene, graphite, fullerenes, and combinations thereof.

17. The carbon film of claim 11, wherein the one or more dispersing agents comprises chlorosulfonic acid and an organic solvent, wherein the organic solvent is selected from the group consisting of chloroform and dichloromethane.

18. The carbon film of claim 11, wherein the carbon film is substantially free of polymers, surfactants, and dispersing agents.

19. The carbon film of claim 11, wherein the carbon film comprises carbon nanostructures with lengths of more than about 500 nm.

20. A carbon film,
wherein the carbon film has a thickness of less than about 20 nm, and
wherein the carbon film is substantially free of polymers, surfactants, and dispersing agents.

21. The carbon film of claim 20, wherein the carbon film comprises SWNTs.

22. The carbon film of claim 20, wherein the carbon film floats freely in water.

23. The carbon film of claim 20, wherein the carbon film is a monolayer.

24. The carbon film of claim 20, wherein the carbon film has a thickness of less than about 10 nm.

25. The carbon film of claim 20, wherein the carbon film comprises carbon nanostructures with lengths of more than about 500 nm.
